(19) United States
(12) Patent Application Publication
(10) Pub. No.: US 2006/0277113 A1
(43) Pub. Date: Dec. 7, 2006

(54) Method Of Doing Business By Locating And Obtaining Products Or Services Using A Web-Based Vehicle

(76) Inventor: Randall Richards, DeBary, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/422,792

(22) Filed: Jun. 7, 2006

Related U.S. Application Data
(60) Provisional application No. 60/688,883, filed on Jun. 7, 2005.

(51) Int. Cl. G06Q 30/00

(52) U.S. Cl. 705/26

(57) ABSTRACT

A web-based system to facilitate sales within a network including buyers, suppliers and agents. The system may include a first database configured to store information of buyers, a second database configured to store information of suppliers and a third database configured to store information of referral agents. The system may further include system processing software for (i) assisting in selection of a referral agent for a buyer identified in the first database based on a buyer request, (ii) providing the agent with information describing the buyer request and (iii) enabling the agent to obtain a listing of suppliers identifiable in the second database based on specific information relating to the buyer request. In another embodiment the system may include system processing software for (i) assisting in selection of an agent for a supplier identified in the second database based on a supplier request, (ii) providing the agent with information describing a product or service of the supplier and (iii) enabling the agent to obtain a listing of buyers identified in the first database based on specific information relating to the supplier request.

### SPECIFIC DATA RELATED TO THE INVENTION

This application claims the benefit of U.S. Provisional Application No. 60/688,883, filed Jun. 7, 2005.

### FIELD OF THE INVENTION

The present invention relates to a web-based system for locating and obtaining products or services and, more particularly, to a system that allows for buyers and suppliers of goods and services to interact directly or through business referral agents for sale of such goods and services.

### BACKGROUND OF THE INVENTION

With the rapid pace at which new products and services are introduced among many industries it is a challenge to timely disseminate information to customers. With continued increases in the international scope of business opportunities, effective communication to an optimum audience can be a relatively expensive endeavor affecting a supplier's margins and increasing the price of goods and services. Even for large companies having efficient marketing and sales infrastructures, the cost of securing a sale is often not an insignificant expense. It can also be an arduous task for buyers to search, locate and compare among a large number of available selections or sources of selections, even when these are searchable through electronic means.

With the internet, heralded as the means for widely sharing information effectively, it is now commonplace for many companies to provide websites which make product or service information readily available. In many instances, the available information may be insufficient for a prospective customer to make a final selection. The customer may require numerous communications to fully evaluate the merits of many available choices. To this end, brokers provide value-added roles in both wholesale and retail markets.

By way of example, the real estate sales field is known to involve time-consuming efforts to initially identify, then evaluate properties and negotiate sales. With access to a common database of available properties, agents from different companies can follow established guidelines for providing information, dealing with ethical issues and sharing commissions. When a potential buyer contacts a real estate agent, the agent can search a listing database shared among agents for properties matching the buyer's criteria. Use of listing services among brokers can facilitate faster sales through cooperative efforts between representatives of buyers and sellers.

More generally, business referrals by independent brokers can add to the sales of small and medium size companies without incurring otherwise more burdensome costs of sales, e.g., greater advertising expenses. However, such use of brokers has been limited, possibly because activities of many brokers are specialized and of finite scope.

Business clubs, facilitating access between buyers and sellers can bring greater efficiency to the transaction. Generally, these clubs are also narrow in scope, sometimes being based on geographical or product areas of interest. The effectiveness of these clubs depends on the level of participation by both buyers and sellers and the desire for a greater geographical scope may be constrained by a need to have frequent, face-to-face meetings.

### SUMMARY OF THE INVENTION

Heretofore, there has not been an effective business referral system which spans the scope of many disparate business activities. Accordingly, there is a need for a cost-effective web-based system to facilitate locating and obtaining products or services and which allows for buyers and sellers of goods and services to interact directly or through agents. In one form of the invention, there is provided a web-based system to facilitate sales within a network including buyers, suppliers and agents.

By way of example, the system may include multiple databases. A first database may be configured to store buyer information, while a second database may be configured to store supplier information and a third database may be configured to store information on referral agents having agreed to terms of participation in transactions and who can be assigned to facilitate transactions between buyers and suppliers. The system may further include system processing software for (i) assisting in selection of a referral agent for a buyer identified in the first database based on a buyer request, (ii) providing the agent with information describing the buyer request and (iii) enabling the agent to obtain a listing of suppliers identifiable in the second database based on specific information relating to the buyer request.

In another embodiment the system may include system processing software for (i) assisting in selection of an agent for a supplier identified in the second database based on a supplier request, (ii) providing the agent with information describing a product or service of the supplier and (iii) enabling the agent to obtain a listing of buyers identified in the first database based on specific information relating to the supplier request.

A method of facilitating sales includes forming a buyer-agent-supplier website under the control of a provider in which multiple buyers, multiple agents and multiple suppliers coordinate to effect sales, establishing a first database of buyers and establishing a second database of referral agents, and establishing a third database identifying the suppliers. The third database is accessible by referral agents through the website, wherein a plurality of suppliers provide information describing products or services available for sale through the website and each enters into a contract with the provider to establish a sales commission arrangement to compensate referral agents who facilitate sales of the products or services through the website.

In another embodiment of the invention, a method of facilitating sales includes forming a buyer-agent-supplier website under the control of a provider in which multiple buyers, multiple agents and multiple suppliers coordinate to effect sales. A first database of referral agents is established and a second database identifying the suppliers is also established. The second database is accessible by referral agents through the website, wherein a plurality of suppliers provides information describing products or services available for sale through the website and each supplier enters into a contract with the provider to establish a sales commission arrangement to compensate referral agents who facilitate sales of the products or services through the website. A third database, formed to identify the buyers, is accessible by referral agents through the website, wherein buyers provide information describing products or services needed. According to the method, a supplier may provide initial information to the website in order to sell a product or service to a buyer identified in the database of buyers, and a referral agent assigned to the supplier uses information provided by the supplier to obtain a list of candidate buyers from the third database and provides the list of candidate buyers to the supplier.

### DESCRIPTION OF THE FIGURES

The invention will be more clearly understood from the following description of embodiments given by way of example only, with reference to the accompanying drawings, in which:

FIG. 1 describes organization of a website-based business referral system according to the invention;

FIG. 2 illustrates the functional interface of Buyer members to the system of FIG. 1;

FIG. 3 illustrates the functional interface of Supplier members to the system of FIG. 1;

FIG. 4 illustrates the functional interface of Referral Agent members to the system of FIG. 1;

FIG. 5 illustrates the functional interface of Independent Referral Agent members to the system of FIG. 1;

FIG. 6 illustrates the functional interface of Administrators to the system of FIG. 1;

FIG. 7A illustrates exemplary information flow in the system of FIG. 1;

FIG. 7B illustrates exemplary information flow between a Buyer member and databases of the system of FIG. 1;

FIG. 7C illustrates exemplary information flow between a Supplier member and databases of the system of FIG. 1;

FIG. 7D illustrates exemplary information flow between a Referral Agent member and databases of the system of FIG. 1;

FIG. 7E illustrates exemplary information flow between an Independent Referral Agent member and databases of the system of FIG. 1;

FIG. 7F illustrates exemplary information flow between an Administrator and databases of the system of FIG. 1;

FIG. 8 is a flowchart describing a referral process in accordance with an embodiment of the present invention;

FIG. 9 is a flowchart describing a referral process in accordance with another embodiment of the present invention;

FIG. 10 is a flowchart describing another process in accordance with an embodiment of the present invention; and

FIG. 11 is a flowchart describing a referral process in accordance with still another embodiment of the present invention.

### DETAILED DESCRIPTION OF THE INVENTION

According to one embodiment of the invention, a system, herein referred as a Business Referral System, allows a buyer to locate a source of goods or services, without geographic limitation, directly from a supplier registered with the system or through use of a referral agent registered with the system. The agent may identify registered supplier members of the system or may draw upon a proprietary list of suppliers to locate the goods or services desired by the buyer. The system can be prompted to assign a referral agent to introduce a buyer to a supplier or to introduce a supplier to a buyer.

Such a Business Referral System includes four types of members: (i) Buyer members, e.g., businesses seeking products or services; (ii) Supplier members, e.g., businesses selling products or services; (iii) Referral Agents, e.g., individuals or businesses which seek to refer buyer members and supplier members to one another, and (iv) Independent Referral Agents, e.g., independent members who can add an unlimited number of proprietary business contacts to facilitate sales to buyer members or to facilitate sales by supplier members. Each type of member has access to a tailored interface of the Business Referral System. In addition, Administrators of the system access an operational interface with authority to make changes to the system and its functionality and edit databases. Administrators also oversee responses to member inquiries and support basic system functions such as extracting data and corresponding with members.

Members of the Business Referral System agree to terms of participation in the system and terms relating to transactional activities. Members post profiles on the system website, and in order to be contacted by the system provider and other members who obtain such information from the website. When two members communicate through the system, they provide their contact information (e.g., name, telephone number, e-mail address, and company name) to one another. In the Business Referral System, when a sale is made through the system with the involvement of a referral agent, a referral commission is paid to the agent by the Supplier member who makes the sale. If the sale is initiated by an Independent Referral Agent, part or all of the commission is paid to the Independent Referral Agent member.

A feature of numerous embodiments relates to the assignment of a Referral Agent member when a Buyer member requests a product or service through the Business Referral System. A Referral Agent can be assigned to manage each Buyer request with responsibility for identifying potential Suppliers (e.g., via searches on the website), contacting the Suppliers for information or quotes, managing requests, and communicating to the Buyer and the Suppliers. The Referral Agent can be a sales advocate for Supplier members or a facilitator and negotiator for Buyer members. Furthermore, Referral Agents can refer businesses through other Referral Agents. Alternately, Buyer members and Supplier members can make direct sales without engaging Referral Agents.

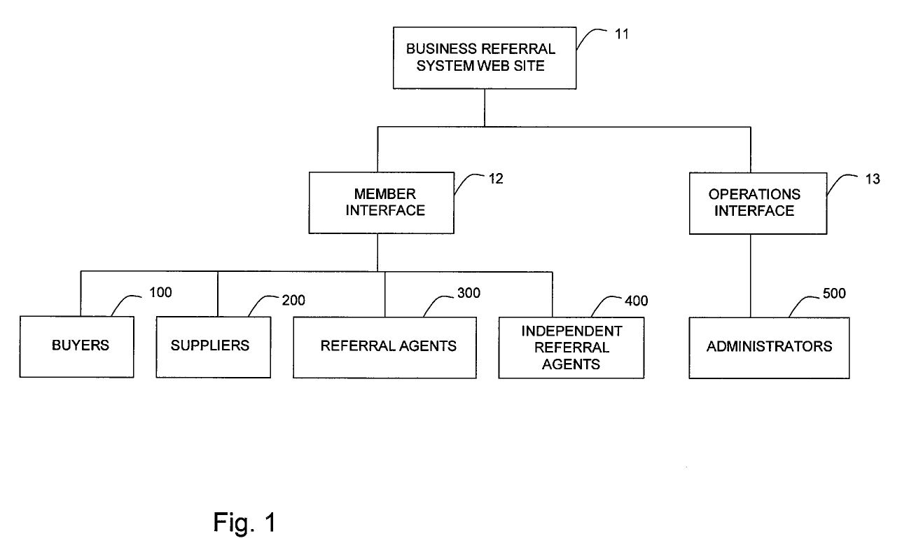

With reference to FIG. 1, the exemplary Business Referral System 1 includes a Website 11 with, generally, two interface sections. A Member Interface 12 allows direct access by members, including Buyers 100, Suppliers 200, Referral Agents 300, and Independent Referral Agents 400. An Operations Interface 13 provides the functional oversight and report generating capability used by Administrators 500.

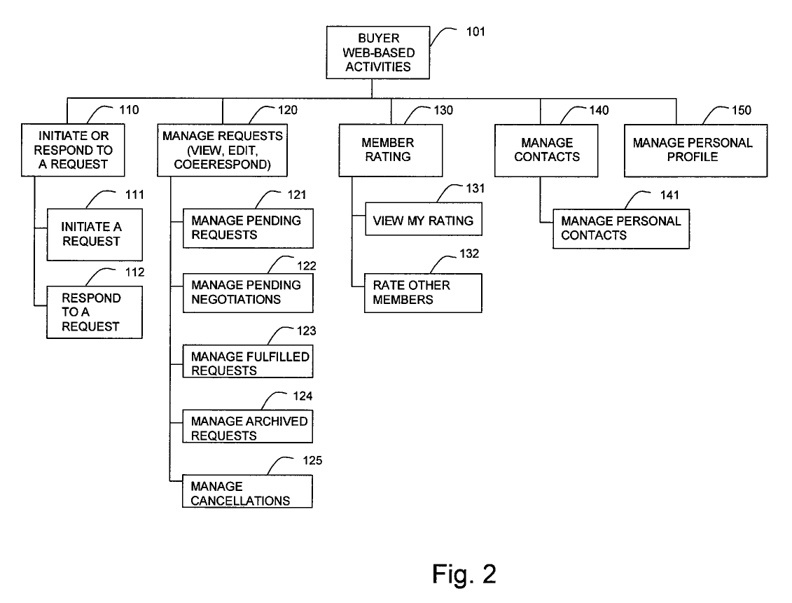

As illustrated in FIG. 2, exemplary web-based activities 101 of a Buyer 100 include task 110, “INITIATE OR RESPOND TO A REQUEST”; task 120, “MANAGE REQUESTS”; task 130, “MEMBER RATING”; task 140, “MANAGE CONTACTS”; and task 150, “MANAGE PERSONAL PROFILE.” Under task 110, “INITIATE OR RESPOND TO A REQUEST”, a Buyer 100 may initiate a request (task 111) for a product or service. In response, an Administrator 500 of the Business Referral System 1 will assign a Referral Agent 300 to assist in fulfilling the request. Under task 120, “MANAGE REQUESTS”, a Buyer 100 may view, manage, and correspond about pending requests (task 121), pending negotiations (task 122), fulfilled requests (task 123), archived requests (task 124) and cancellations (task 125). Under task 130, “MEMBER RATING”, a Buyer 100 may view its own ratings (task 131) and rate other members (task 132) in order to inform the system and members of positive or negative experiences with the other members. This function generally helps enforce member rights and serves as a quality assurance measure. With task 140, “MANAGE CONTACTS”, a Buyer 100 can add, view and manage personal contacts (task 141) acquired through the Business Referral System 1. With task 150, “MANAGE PERSONAL PROFILE”, a Buyer 100 can view and edit its member profile. The profile comprises detailed information about the member. Each member group has a profile format that is tailored to the purpose of the membership.

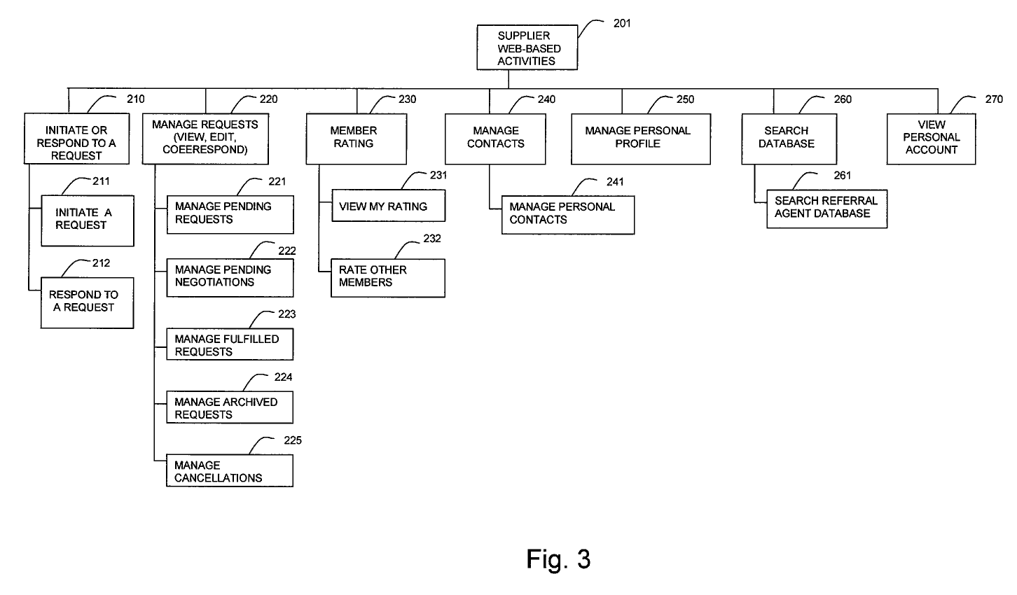

As illustrated in FIG. 3, exemplary Supplier web-based activities 201 include task 210, “INITIATE OR RESPOND TO A REQUEST”; task 220, “MANAGE REQUESTS”; task 230, “MEMBER RATING”; task 240, “MANAGE CONTACTS”; task 250, “MANAGE PERSONAL PROFILE”; task 260, “SEARCH DATABASE”; and task 270, “VIEW PERSONAL ACCOUNT”. Under task 210, “INITIATE OR RESPOND TO A REQUEST”, a Supplier 200 responds to a request for a bid (task 212) from a Referral Agent 300 or a Buyer 100, by either accepting or declining the request. Under task 220, “MANAGE REQUESTS”, a Supplier 200 views, manages, and corresponds about pending requests (task 221), pending negotiations (task 222), fulfilled requests (task 223), archived requests (task 224) and cancellations (task 225). Under task 230, “MEMBER RATING”, a Supplier 200 views its own ratings (task 231) and rates other members (task 232) in order to inform the system and its members of positive or negative experiences. Under task 240, “MANAGE CONTACTS”, a Supplier 200 can add, view and manage contacts acquired through the Business Referral System 1 (task 241). Under task 250, “MANAGE PERSONAL PROFILE”, a Supplier 200 can view and edit its member profile. Under task 260, “SEARCH DATABASE”, a Supplier 200 can search the Referral Agent Database 713 to promote its products or services (task 261). A Referral Agent 300 can be located by a Supplier 200 using keywords referencing the industry and geographic location of interest, or searching by member identification number. Under task 270, “VIEW PERSONAL ACCOUNT”, a Supplier 200 can view all filled requests and the payment status in an associated accounting system.

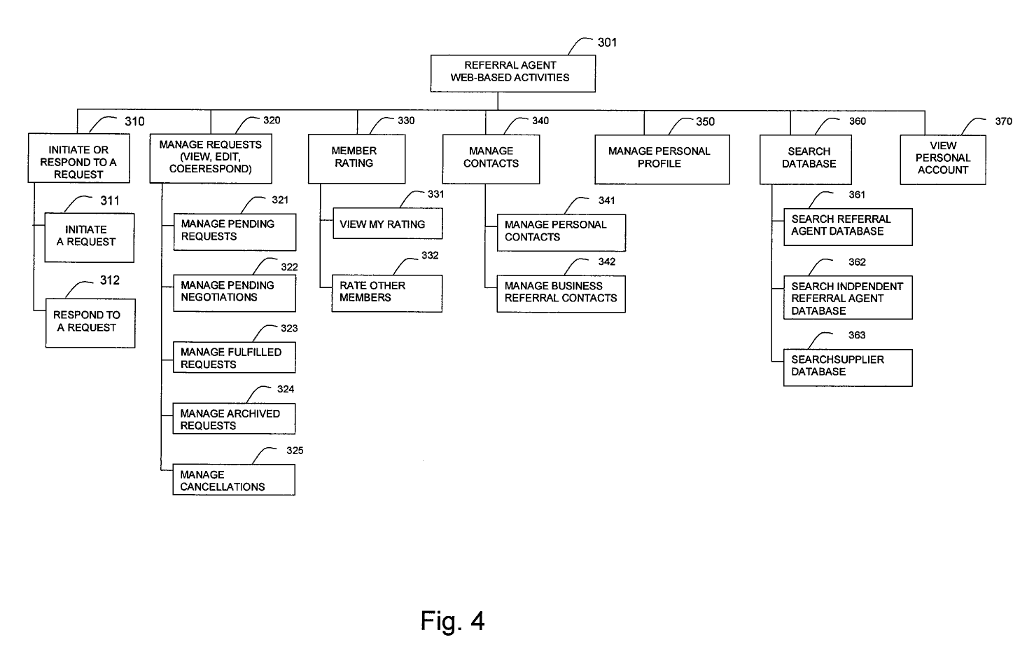

As illustrated in FIG. 4, exemplary Referral Agent web-based activities 301 include task 310, “INITIATE OR RESPOND TO A REQUEST”; task 320, “MANAGE REQUESTS”; task 330, “MEMBER RATING”; task 340, “MANAGE CONTACTS”; task 350, “MANAGE PERSONAL PROFILE”; task 360, “SEARCH DATABASE”; and task 370, “VIEW PERSONAL ACCOUNT”. Under task 310, “INITIATE OR RESPOND TO A REQUEST”, a Referral Agent 300 can initiate a request for a product or service on behalf of a buyer 100 or even for its own business needs and can respond to a referral request (task 311) from an Administrator 500 which may have been initiated by a Buyer 100 or by another Referral Agent 300, by either accepting or declining it. Under task 320, “MANAGE REQUESTS”, a Referral Agent 300 can view, manage, and correspond about pending requests (task 321), pending negotiations (task 322), filled requests (task 323), archived requests (task 324) and cancellations (task 325).

A Referral Agent 300 manages each Buyer's request by identifying potential Suppliers 200 for the Buyer 100 to view online; contacting Suppliers 200 for information or quotes; editing requests for bids; posting comments to the Buyer 100 and Suppliers 200; and canceling requests for bid. A Referral Agent 300 can view filled requests initiated by Buyers 100 to which that Referral Agent was assigned.

Under task 330, “MEMBER RATING”, a Referral Agent 300 can view its own ratings (task 331) and rate other members (task 332) in order to inform the system and its members of positive or negative experiences. Under task 340, “MANAGE CONTACTS”, a Referral Agent 300 can add, view and manage contacts acquired through the Business Referral System 1 (task 341). A Referral Agent 300 may also add, view, and manage an unlimited number of business referral contacts, including contacts who are not members of the Business Referral System 1, to the Independent Referral Agent Database (task 342). These contacts are searchable by other Referral Agents to help identify opportunities for sales.

Under task 350, “MANAGE PERSONAL PROFILE”, a Referral Agent 300 can view and manage its member profile. Under task 360, “SEARCH DATABASE”, a Referral Agent 300 may search the Referral Agent Database 713 for other Referral Agents (task 361) and the Independent Referral Agent Database 714 (task 362) for additional agents to assist with the fulfillment of an assigned request. The Supplier Database 712 is also available for a Referral Agent 300 to search (task 363) in order to identify an opportunity to complete a sale. Under task 370, “VIEW PERSONAL ACCOUNT”, a Referral Agent 300 views all filled requests and the payment status in the provided accounting system.

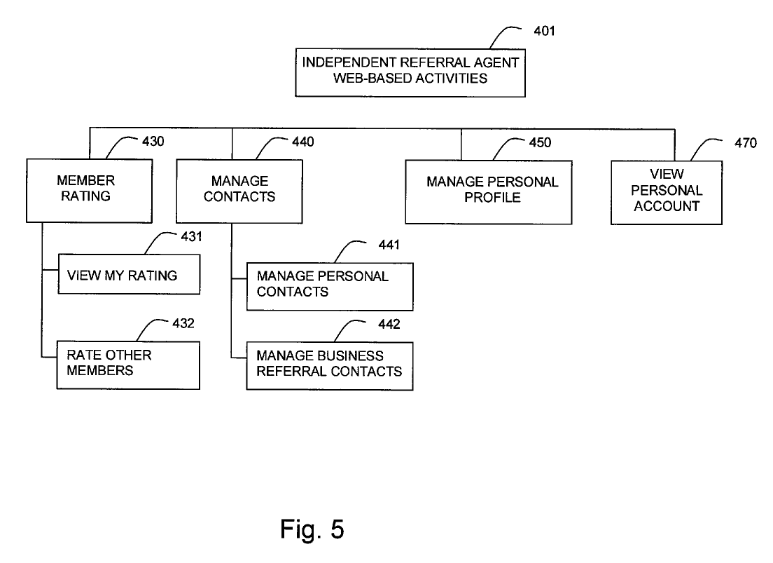

As illustrated in FIG. 5, exemplary web-based activities 401 of Independent Referral Agents 400 include task 430, “MEMBER RATING”; task 440, “MANAGE CONTACTS”; task 450, “MANAGE PERSONAL PROFILE”; and task 470, “VIEW PERSONAL ACCOUNT”. Under task 430, “MEMBER RATING”, an Independent Referral Agent 400 views its own ratings (task 431) and rates other members (task 432) in order to inform the system and its members of positive or negative experiences with the other members.

Under task 440, “MANAGE CONTACTS”, an Independent Referral Agent 400 can add, view and manage contacts acquired through the Business Referral System 1 (task 441). An Independent Referral Agent 400 can also add, view, and manage an unlimited number of business referral contacts, e.g., buyers who are not members of the Business Referral System 1, to the Independent Referral Agent Database (task 442). These contacts are searchable by Referral Agents 300 to help identify sales opportunities. Under task 450, “MANAGE PERSONAL PROFILE”, an Independent Referral Agent 400 can view and manage its member profile. Under task 470, “VIEW PERSONAL ACCOUNT”, an Independent Referral Agent 400 can view all filled requests and the payment status in the provided accounting system.

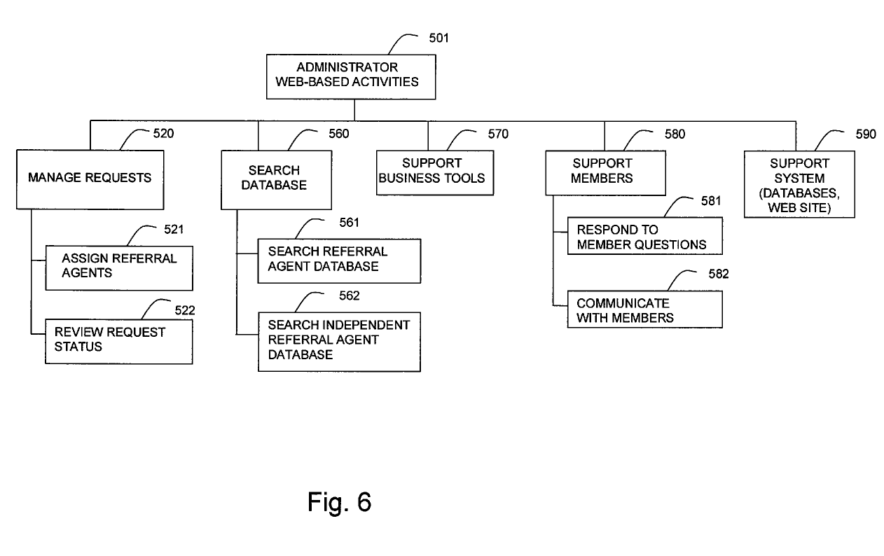

As illustrated in FIG. 6, exemplary web-based activities 501 of Administrators 500 include task 520, “MANAGE REQUESTS”; task 560 “SEARCH DATABASE”; task 570, “SUPPORT BUSINESS TOOLS”; task 580, “SUPPORT MEMBERS”; and task 590, “SUPPORT SYSTEM”. Under task 520, “MANAGE REQUESTS”, an Administrator 500 receives a request from a Buyer 500 or a Referral Agent 300 and assigns a Referral Agent 300 to the request (task 521). An Administrator 500 reviews the status of requests periodically (task 522) to monitor the progress made by a Referral Agent 300. Under task 560, “SEARCH DATABASE”, an Administrator 500 can search the Referral Agent Database 713 (task 561) to identify a candidate Referral Agent 300 to assign a request and the Independent Referral Agent Database 714 (task 562) to identify potential sales opportunities. Under task 570, “SUPPORT BUSINESS TOOLS”, an Administrator 500 supports business tools offered by the Business Referral System 1 including an accounting service.

Under task 580, “SUPPORT MEMBERS”, an Administrator 500 supports members by providing answers to questions from members (task 581) and communicates with members via e-mail or other methods (task 582) to inform members about changes in the Business Referral System 1. Under task 590, “SUPPORT SYSTEM”, an Administrator 500 supports all databases and the Business Referral System website.

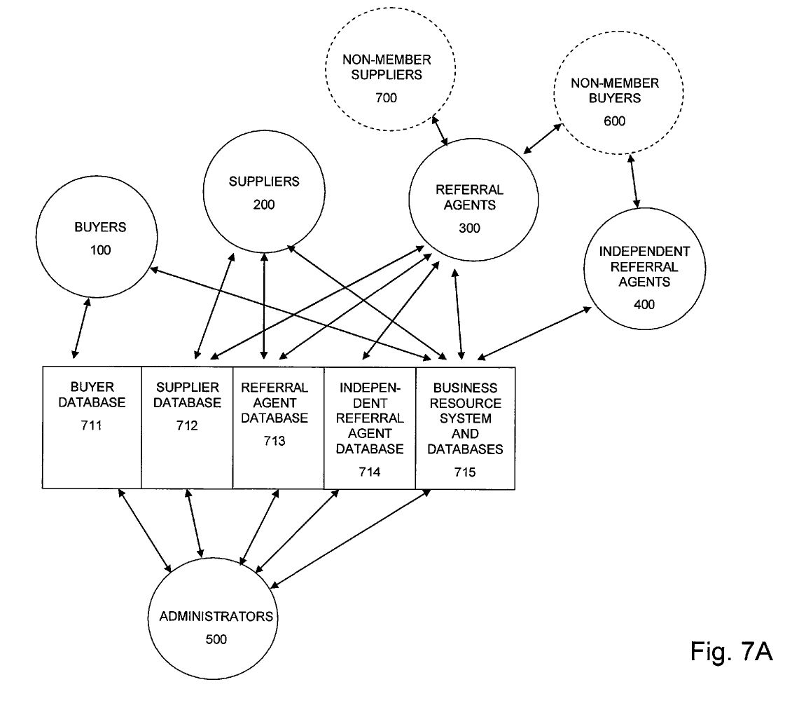

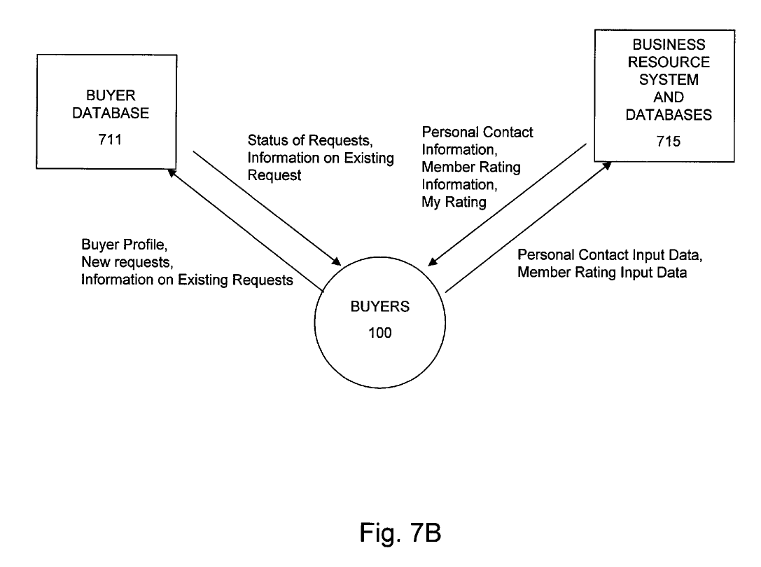

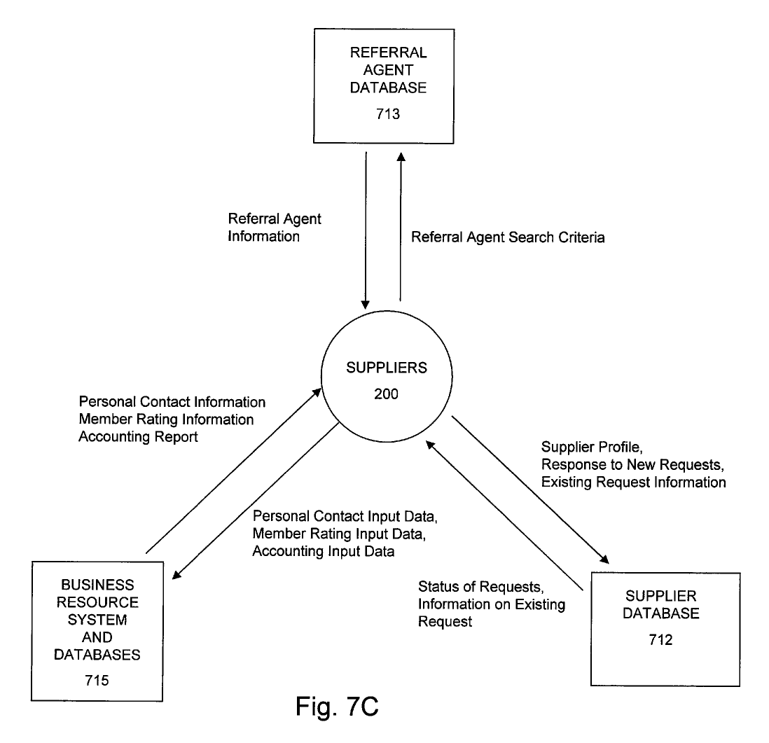

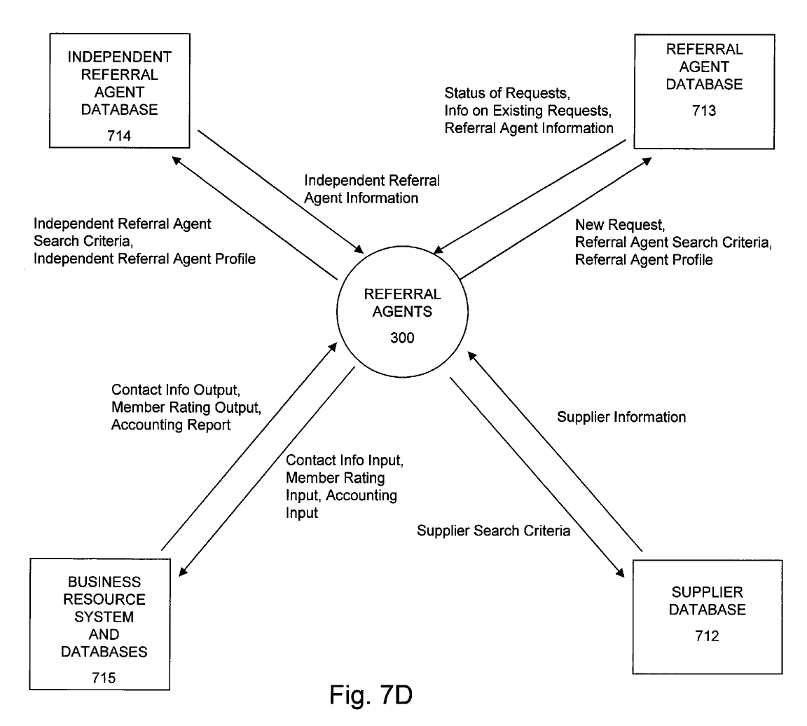

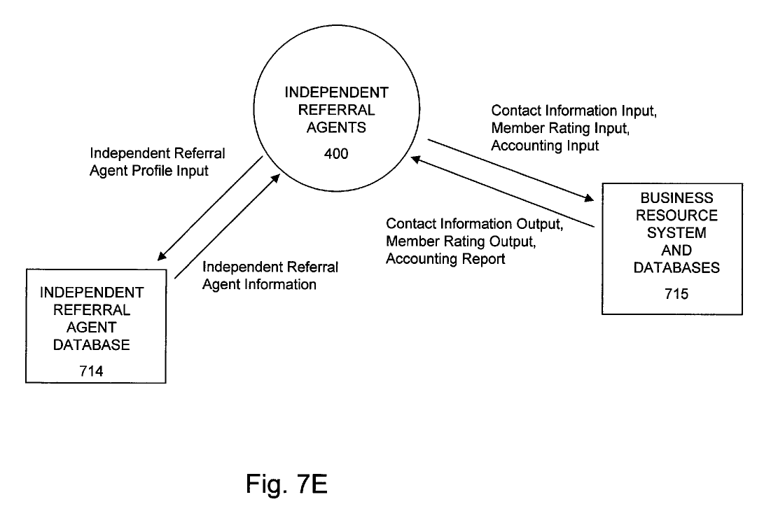

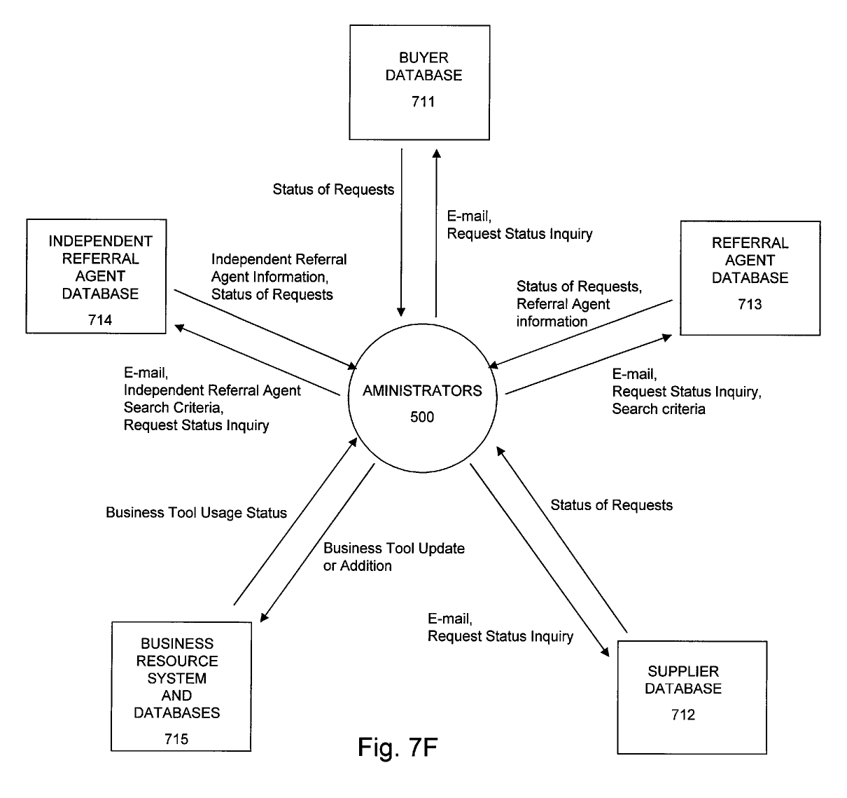

An exemplary database interface structure for the Business Referral System 1 is illustrated in FIG. 7A as including four member databases: (1) a Buyer Member Database 711, (2) a Supplier Member Database 712, (3) a Referral Agent Database 713, and (4) an Independent Referral Agent Database 714. Each database contains member profiles and request files which correspond to requests, (e.g., buyer-initiated requests). All member profiles include a member name, address, contact information (such as phone numbers, fax numbers and e-mail address), business type, and industry-type. Profiles for Buyers 100, Suppliers 200, and Independent Referral Agents 400 may include additional information such as gross revenue, and number of employees. The profile of a Referral Agent 300 also includes such information as countries of business operation and business experience. A request file may include, for example, information on industry-type, type of product or service requested, specifications or other requirements, estimated volume of an order, estimated frequency of an order, and delivery requirements.

In addition to the four member databases, the Business Referral System 1 includes a Business Resource System and Databases 715, providing members with business resources such as accounting, calendar systems, and business contact management. Buyer members 100 can access the Buyer Member Database 711 and Business Resource System and Databases 715. Supplier members 200 can access the Supplier Member Database 712, Referral Agent Member Database 713 and the Business Resource System and Databases 715. Referral agent members 300 can access the Supplier Member Database 712, Referral Agent Member Database 713, Independent Referral Agent Member Database 714 and the Business Resource System and Databases 715. Independent Referral Agent members 400 can access the Business Resource System 715. Administrators 500 have access to all databases of the Business Referral System 1. Referral Agents 300 and Independent Referral Agents 400 can initiate a request for a product or service (task 312) on behalf of buyers who are not members of the Business Referral System 1, herein referred as “Non-member Buyers” 600. Referral Agents 300 and Independent Referral Agents 400 can manage the contact information of Non-member Buyers 600. A Referral Agent 300 can also manage the contact information of suppliers who are not members of the Business Referral System 1, herein referred as “Non-member Suppliers” 700.

FIG. 7B illustrates an example of information flow between Buyers 100 and the Business Referral System databases. Buyers 100 can use the Buyer Member Database 711 to update their profiles and contact information, to initiate new requests, and to manage the requests at various stages, including pending requests, pending negotiations, fulfilled requests, archived requests, and cancelled requests. Buyers 100 can use the Business Resource System and Databases 715 to manage personal contacts acquired through the Business Referral System 1 and to rate other members based on business transaction experience.

FIG. 7C illustrates an example of information flow between Suppliers 200 and the Business Referral System databases. Suppliers 200 can use the Supplier Member Database 712 to update their profiles, to respond to a new request and to view the status of existing requests. Suppliers 200 can search the Referral Agent Member Database 713 to search the Referral Agents 300 who will assist with sales. Suppliers 200 can use the Business Resource System and Databases 715 to manage personal contacts acquired through the business referral system and rate other members based on business transaction experience. Suppliers 200 can also use the accounting tool available through the Business Resource System and Database.

FIG. 7D illustrates an example of information flow between Referral Agents 300 and the Business Referral System databases. Referral Agents 300 can use the Referral Agent Member Database 713 to update their profiles, to initiate new requests, and to view the status of existing requests. Referral Agents can use the Supplier Member Database 712 to match candidate Suppliers to Buyer member requests. Referral Agents 300 can use the Referral Agent Member Database 713 and the Independent Referral Agent Member Database 714 to identify other Referral Agents 300 or Independent Referral Agents 400 who can assist in business transactions. In addition, Referral Agents 300 can post their profiles in the Independent Referral Agent Database 714 for referrals of Non-member Buyers 600. Referral Agents 300 can use the Business Resource System and Databases 715 to manage personal contacts acquired through the Business Referral System, manage contacts of Non-Member Suppliers 700 and rate other members based on business transaction experience. Referral Agents 300 can also use the accounting tool available through the Business Resource System and Databases 715.

FIG. 7E illustrates an example of information flow between Independent Referral Agents 400 and the Business Referral System databases. Independent Referral Agents 400 can use the Independent Referral Agent Database 714 to update their profiles and use the Business Resource System and Databases 715: (i) to manage personal contacts acquired through the Business Referral System, (ii) to manage contacts of Non-member Buyers 600, and (iii) to rate other members based on business transaction experience. Independent Referral Agents 500 can also use the accounting tool available through the Business Resource System and Databases 715.

FIG. 7F illustrates an example of information flow between Administrators 500 and the Business Referral System databases. Administrators 500 can search the Referral Agent Database 713 (task 561) and the Independent Referral Agent Database 714 (task 562) in response to requests from Buyers 100 or Suppliers 200. Administrators 500 can periodically review the status of a request in the Buyer Member Database 711, Supplier Member Database 712, and Referral Agent Member Database 713, to monitor progress. Administrators 500 can monitor the membership status from each member database and use e-mails to communicate with members. Administrators 500 can also support the Business Resource System and Databases 715 by updating the business tools, monitoring usage and addressing problems identified by members.

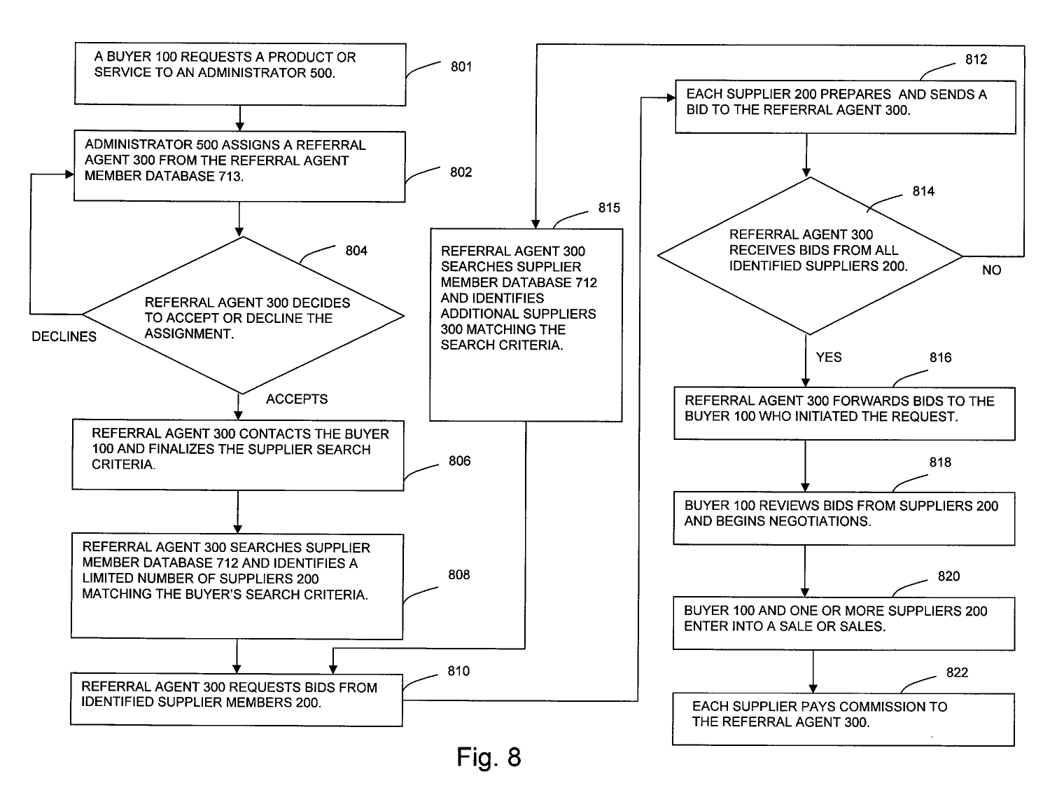

The flowchart of FIG. 8 generally describes a referral process based on a request from a Buyer 100 and participation of a Referral Agent 300 in accordance with an embodiment of the present invention. In step 801 a Buyer Member 100 sends a request for a product or service to an Administrator 500. In step 802, the Administrator 500 assigns a candidate Referral Agent 300 from the Referral Agent Member Database 713. In step 804 the candidate Referral Agent 300 accepts or declines the assignment. If declined, the Administrator 500 assigns another Referral Agent. Steps 802 and 804 continue until the request is accepted by a Referral Agent 300. Next, in step 806, the accepting Referral Agent 300 contacts the associated Buyer 100 who made the request and finalizes supplier search criteria. Criteria may include specification of the product or service needed, number of supplier bids to be requested, acceptable supplier locations, delivery schedules, and volume and frequency of purchases. In step 808 the Referral Agent 300 searches the Supplier Member Database 712 and identifies a limited number of suppliers 200 that match the Buyer's search criteria. In step 810 the Referral Agent 300 requests bids from the identified Suppliers 200. Next, in step 812, each Supplier 200 contacted by the Referral Agent 300 may prepare and send a bid to the Referral Agent 300. In step 814 the Referral Agent 300 reviews the bids received and determines whether each Supplier 200 provided the necessary bid information and addresses deficiencies. If needed, the Referral Agent 300 searches the Supplier Member Database 712 again to identify additional Suppliers 300 (step 815). Steps 810, 812, 814, and 815 continue until all the required Supplier bids are received. In step 816 the Referral Agent 300 forwards the bids to the Buyer 100 who made the Request. In step 818 the Buyer 100 reviews the supplier bids and negotiations begin with participating Suppliers 200 in coordination with the assigned Referral Agent 300. In step 820 the buyer 100 and one or more Suppliers 200 enter into a sale. The Referral Agent 300 receives a commission from the Supplier or Suppliers 200 in step 822.

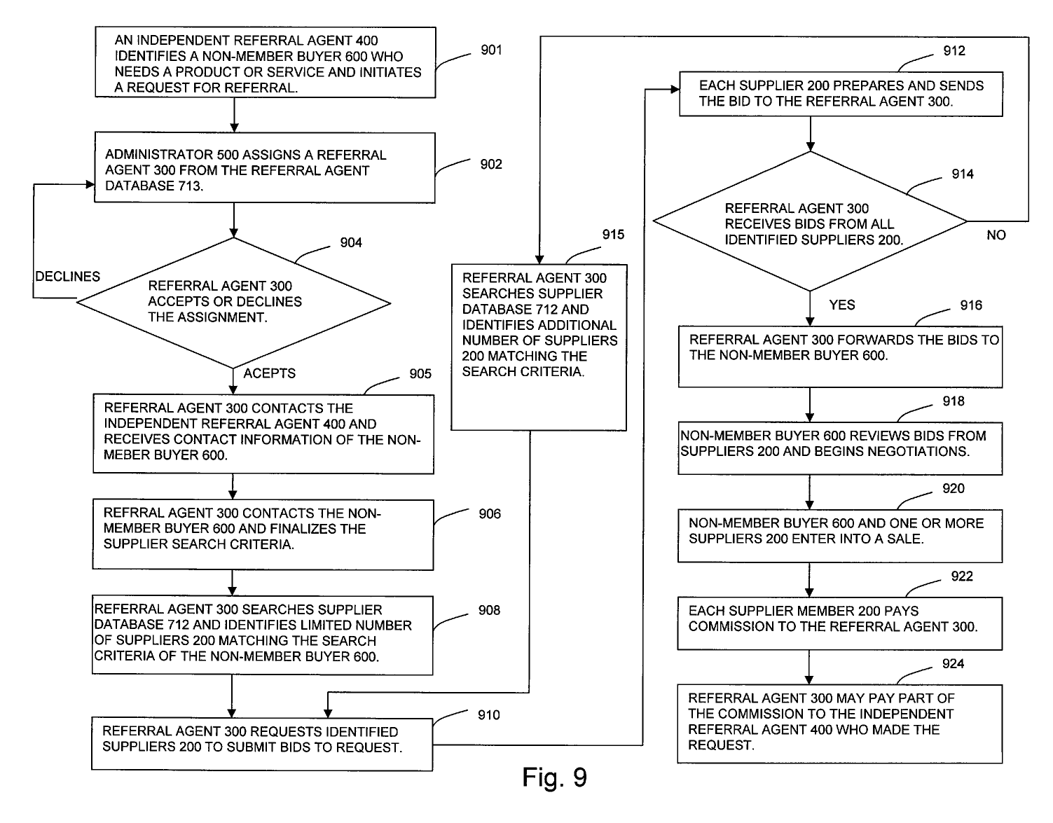

The flowchart of FIG. 9 generally describes a referral process based on a request from an Independent Referral Agent 400 for a Non-member Buyer 600, in accordance with another embodiment of the present invention. In step 901 an Independent Referral Agent Member 400 identifies a Non-member Buyer 600 that needs a product or service and sends a request to an Administrator 500. In step 902, the administrator 500 assigns a candidate Referral Agent 300 from the Referral Agent Member Database 713. In step 904 the candidate Referral Agent 300 accepts or declines the assignment. If declined, the Administrator 500 assigns another Referral Agent 300. Steps 902 and 904 continue until the request is accepted by a Referral Agent 300. In step 905 the assigned Referral Agent 300 contacts the Independent Referral Agent 400 that sent the request and obtains the contact information of the Non-member Buyer 600. Next, in step 906, the assigned Referral Agent 300 contacts the associated Non-member Buyer 600 and finalizes supplier search criteria. Criteria may include specification of the product or service needed, number of supplier bids to be requested, acceptable supplier locations, delivery schedules, and volume and frequency of purchases. In step 908 the Referral Agent 300 searches the Supplier Member Database 712 and identifies a limited number of Suppliers 200 that match the Buyer's search criteria. In step 910 the Referral Agent 300 requests bids from the identified Suppliers 200. Next, in step 912, each Supplier 200 contacted by the Referral Agent may prepare and send a bid to the Referral Agent 300. In step 914 the Referral Agent 300 reviews the bids received and determines whether each Supplier 200 provided the necessary bid information and addresses deficiencies. If needed, the Referral Agent 300 searches the Supplier Member Database 712 again to identify additional Suppliers 200 (step 915). Steps 910, 912, 914, and 915 continue until all the required supplier bids are received. In step 916 the Referral Agent 300 forwards the bids from Suppliers 200 to the Non-member Buyer 600. In step 918 the Non-member Buyer 600 reviews the supplier bids. Negotiations begin with Suppliers 200 in coordination with the assigned Referral Agent 300. In step 920 the Non-member Buyer 600 and one or more Suppliers 200 enter into a sale. The Referral Agent 300 receives a commission from the Supplier or Suppliers 200 in step 922. In step 924 the Referral Agent 300 may pay part of the commission to the Independent Referral Agent 400 that referred the Non-member Buyer 600 to the Business Referral System 1.

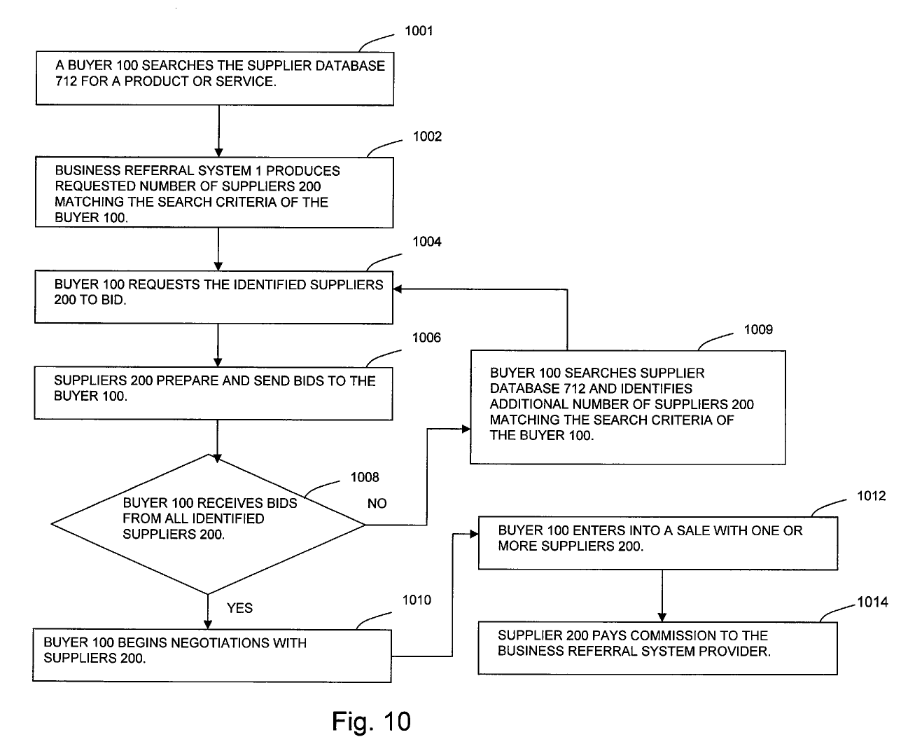

FIG. 10 is a flowchart that generally describes a referral process with a request from by a Buyer 100 followed by direct contacts between the Buyer 100 and Suppliers 200 in accordance with another embodiment of the present invention. In step 1001 a Buyer 100 searches the Supplier Member Database 712 with search criteria. Criteria may include specification of the product or service needed, number of supplier bids, supplier location, delivery schedule to meet, and volume and frequency of sales. In step 1002, the Business Referral System 1 identifies a limited number of Suppliers 200 that match the Buyer's search criteria. In step 1004 the Buyer 100 requests bids from the identified Suppliers 200. Next, in step 1006 each supplier 200 may prepare and send a bid to the Buyer 100. In step 1008 the Buyer 100 reviews the bids received and determines whether each Supplier 200 provided the necessary bid information and addresses deficiencies. If needed, the Buyer 100 searches the Supplier Member Database 712 again to identify additional Suppliers 200 (step 1009). Steps 1004, 1006, 1008, and 1009 continue until all the required supplier bids are received. In step 1010 the Buyer 100 begins negotiations with Supplier members 200. In step 1012 the Buyer 100 and one or more Suppliers 200 enter into a sale. In step 1014 the Supplier or Suppliers 200 may pay a commission to the provider of the Business Referral System 1.

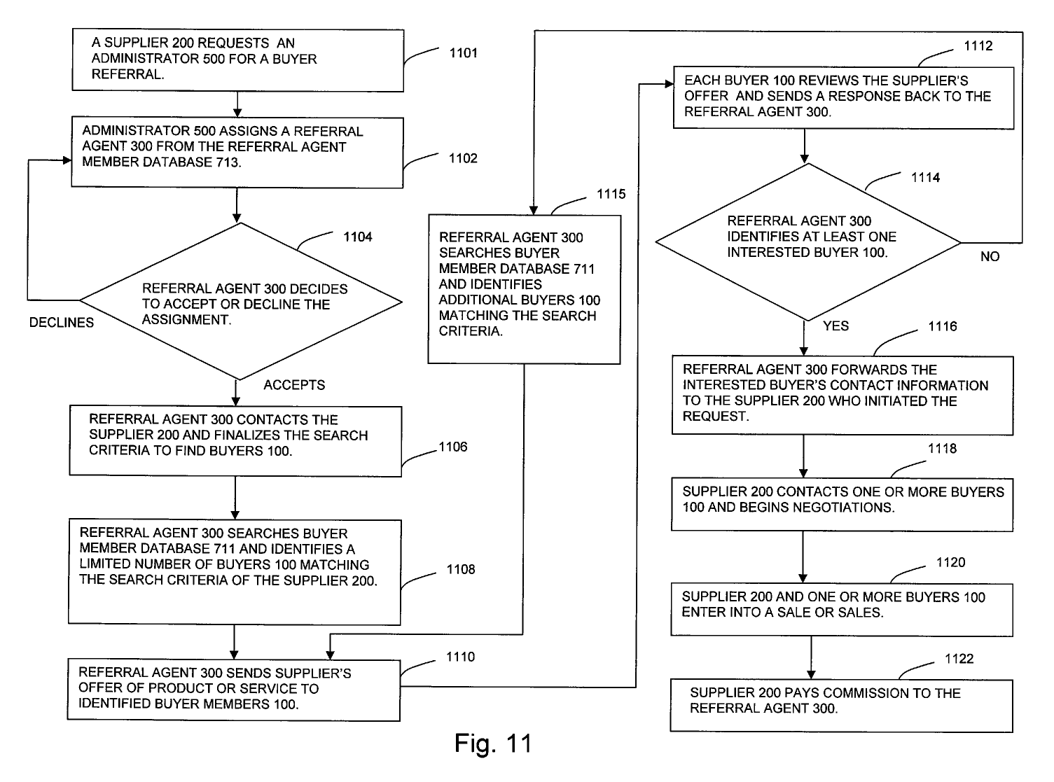

FIG. 11 is a flowchart that generally describes a referral process with a request from a Supplier 200 and a participating Referral Agent 300 in accordance with another embodiment of the present invention. In step 1101 a Supplier Member 200 sends a request to an Administrator 500 in order sell a product or service through the Business Referral System 1. In step 1102, the Administrator 500 assigns a candidate Referral Agent 300 from the Referral Agent Member Database 713. In step 1104 the candidate Referral Agent 300 accepts or declines the assignment. If declined, the Administrator assigns another Referral Agent 300. Steps 1102 and 1104 continue until the request is accepted by a Referral Agent 300. Next, in step 1106, the accepting Referral Agent 300 contacts the associated Supplier 200 and finalizes the buyer search criteria. In step 1108 the Referral Agent 300 searches the Buyer Member Database 711 and identifies a limited number of Buyers 200 that matches the Supplier's search criteria. In step 1110 the Referral Agent sends Supplier's offer related to the product or service including price information to the identified Buyers 100. In step 1112 each Buyer 100 reviews the Supplier's offer and sends a response back to the Referral Agent 300. If none of the Buyers are interested in the Buyer's offering, the Referral Agent 300 may search the Buyer Member Database 711 to identify additional Buyers (step 1115). Steps 1108, 1110, and 1115 continue until a candidate Buyer 100 is identified. In step 1116 the Referral Agent forwards the contact information of the buyer or buyers 100 who are interested in the Supplier's offer of products or services. The Supplier 200 begins negotiations with interested Buyers 100 in coordination with the assigned Referral Agent 300. In step 1120 the supplier 200 and one or more Buyers 100 enter into a sale. The Referral Agent 300 receives a commission from the Supplier 200 in step 1122.

The foregoing description and drawings merely explain and illustrate the invention, and the invention is not limited thereto. Those skilled in the art will be able to make modifications and variations to the afore-described systems and methods without departing from the scope of the invention which is only to be limited by the claims which follow.

What is claimed is:

1. A web-based system to facilitate sales within a network comprising buyers, suppliers and agents, the system comprising:
a first database configured to store information of buyers having agreed to buyer terms of participation in transactions;
a second database configured to store information of suppliers having agreed to supplier terms of participation in transactions;
a third database configured to store information of referral agents having agreed to terms for facilitating transactions and who facilitate transactions between buyers and suppliers; and
system processing software for (i) assisting in selection of a referral agent for a buyer identified in the first database based on a buyer request, (ii) providing the agent with information describing the buyer request, and (iii) enabling the agent to obtain a listing of suppliers identifiable in the second database based on specific information relating to the buyer request.

2. The system of claim 1 further including membership software for obtaining information from buyers, suppliers and referral agents, enabling each to become a member under predefined terms including a sales commission arrangement between suppliers and referral agents.

3. The system of claim 1 further including an additional database including additional agents, having agreed to terms for facilitating transactions, for identifying one or more buyers not included in the first database to suppliers included in the second database.

4. The system of claim 1 further including an additional database providing suppliers and referral agents with resources including contract terms and accounting reports.

5. A web-based system to facilitate sales within a network of buyers, sellers and agents, the system comprising:
a first database configured to store information of buyers having agreed to buyer terms of participation in transactions
a second database configured to store information of suppliers having agreed to supplier terms of participation in transactions;
a third database configured to store information of agents having agreed to terms of participation in transactions and who facilitate transactions between buyers and suppliers; and
system processing software for (i) assisting in selection of an agent for a supplier identified in the second database based on a supplier request, (ii) providing the agent with information describing a product or service of the supplier, and (iii) enabling the agent to obtain a listing of buyers identified in the first database based on specific information relating to the supplier request.

6. The system of claim 5 further including membership software for obtaining information from buyers, suppliers and referral agents, enabling each to become a member under predefined terms including a sales commission arrangement between suppliers and referral agents.

7. The system of claim 5 further including a fourth database including additional agents having agreed to terms of participation in transactions, for identifying, to suppliers included in the second database, buyers, not included in the first database.

8. The system of claim 5 further including an additional database providing suppliers and referral agents with resources including contract terms and accounting reports.

9. A method of facilitating sales, comprising the steps of:
forming a buyer-agent-supplier website under the control of a provider in which multiple buyers, multiple agents and multiple suppliers coordinate to effect sales;
establishing a first database of buyers and establishing a second database of referral agents; and
establishing a third database identifying the suppliers, accessible by referral agents through the website, wherein a plurality of suppliers provide information describing products or services available for sale through the website and each enters into a contract with the provider to establish a sales commission arrangement to compensate referral agents who facilitate sales of the products or services through the website.

10. The method of claim 9 further including the steps of:
providing initial information from a buyer included in the first database to the website in order to seek a product or service from a supplier identified in the database of suppliers;
assigning a referral agent to use information provided by the buyer to obtain a list of candidate suppliers of the product or service from the third data base; and
the agent providing the list of candidate suppliers to buyer.

11. The method of claim 9 further including the steps of:
forming a fourth data base comprising additional referral agents;
identifying buyers in addition to buyers identified in the first database through assistance of agents identified in the fourth database; and
allowing agents identified in the fourth database to facilitate sale of a product or service by a supplier identified in the third database with one of the buyers identified by an agent included in the fourth database.

12. The method of 9 further including the steps of:
forming a fourth data base comprising additional referral agents;
identifying suppliers in addition to suppliers identified in the third database through assistance of agents in the fourth database;
allowing agents identified in the fourth database to facilitate sale of a product or service by a supplier identified by an agent in the fourth database to a buyer in the first database.

13. The method of claim 10 further including the step of the supplier paying the referral agent a commission based on sale of the product or service to the buyer.

14. The method of claim 9 further including a system and database of information services for providing suppliers and referral agents with resources including contract forms and accounting reports.

15. A method of facilitating sales, comprising the steps of:
forming a buyer-agent-supplier website under the control of a provider in which multiple buyers, multiple agents and multiple suppliers coordinate to effect sales;
establishing a first database of referral agents;
establishing a second database identifying the suppliers and accessible by referral agents through the website, wherein a plurality of suppliers provide information describing products or services available for sale through the website and each enters into a contract with the provider to establish a sales commission arrangement to compensate referral agents who facilitate sales of the products or services through the website;
establishing a third database identifying the buyers and accessible by referral agents through the website, wherein a plurality of buyers provide information describing products or services needed;
providing initial information from a supplier to the website in order to sell a product or service to a buyer identified in the database of buyers;
assigning a referral agent to the supplier;
using information provided by the supplier to obtain a list of candidate buyers from the third database; and
providing the list of candidate buyers to supplier.

16. The method of claim 15 further including the steps of:
forming a fourth data base comprising additional referral agents;
identifying suppliers in addition to suppliers identified in the second database through assistance of agents identified in the fourth database; and
allowing agents identified in the fourth database to facilitate sale of a product or service by a supplier identified by the agent included in the fourth database with one of the buyers in the third database.

17. The method of 15 further including the steps of:
forming a fourth data base comprising additional referral agents;
identifying buyers in addition to buyers identified in the third database through assistance of agents identified in the fourth database;
allowing agents identified in the fourth database to facilitate sale of a product or service offered by a supplier in the second database to a buyer identified by the agents in the fourth database.

18. The method of claim 15 further including the step of the supplier paying the referral agent a commission based on sale of the product or service to the buyer.

19. The method of claim 15 further including a system and database of information services providing suppliers and referral agents with resources including contract forms and accounting reports.
